(19) United States
(12) Patent Application Publication
(10) Pub. No.: US 2024/0400399 A1
(43) Pub. Date: Dec. 5, 2024

(54) SPHERICAL MESOPOROUS SILICA AND PREPARATION METHOD THEREOF

(71) Applicant: CEN CO., LTD., Busan (KR)

(72) Inventors: Sang Cheol HAN, Busan (KR); Sang Eon PARK, Incheon (KR)

(21) Appl. No.: 18/687,243

(22) PCT Filed: Jun. 24, 2022
(86) PCT No.: PCT/KR2022/009048

§ 371 Date: Feb. 27, 2024

(30) Foreign Application Priority Data
Sep. 9, 2021 (KR) 10-2021-0120432

(51) Int. Cl. C01B 33/18

(52) U.S. Cl. CPC C01B 33/18; C01P 2004/03; C01P 2004/04; C01P 2004/32; C01P 2004/52; C01P 2004/62; C01P 2004/64; C01P 2006/12; C01P 2006/14; C01P 2006/16

(57) ABSTRACT

Spherical mesoporous silica and a production method therefor are described. According to embodiments, it is possible to provide spherical mesoporous silica characterized by funnel-shaped pores having a large entrance size, and improve economic efficiency and production yield by simplifying the process for production of the spherical mesoporous silica. Further, it is possible to provide spherical mesoporous silica which has excellent adsorption performance due to its large specific surface area and pore volume, is capable of exhibiting an effect of releasing an adsorbed component for a long time after adsorption, and thus is highly usable as a delivery carrier, and a production method therefor.

### TECHNICAL FIELD

The present invention relates to spherical mesoporous silica and a production method therefor, and specifically, to spherical (ball type) porous silica having a groove-shaped surface derived from mesopores and a production method therefor.

### BACKGROUND ART

In general, a method for synthesis of mesoporous silica has mainly been a synthesis method using a surfactant as a template. Depending on the method of interaction between the surfactant and silica, an important factor for synthesis is pH adjustment to acidic, basic, or neutral conditions.

Conventionally known mesoporous silica nanoparticles have a porous structure including pores of a certain size depending on the size of the template. In the case of these nanoparticles, a problem may arise in that the adsorption or desorption of large molecules such as drugs is relatively reduced or limited. In the use of the mesoporous silica nanoparticles, there is a problem in that the diffusion efficiency of particularly large molecules is greatly reduced.

In addition, a method of producing the conventional mesoporous silica has been performed under acidic or basic conditions as described above. At this time, regarding the acidic or basic conditions, the reaction for production proceeds under strongly acidic or strongly basic conditions which are a harsh environment, and thus environmental pollution problems due to the production environment inevitably follow. Moreover, even under such strongly acidic or strongly basic conditions, the reaction for production should be carried out under high-temperature conditions to produce mesoporous silica, and for this reason, high-pressure equipment to withstand hydrothermal pressure and great energy consumption are required, causing problems in terms of mass production. In addition, due to these difficulties in the production process, problems arise in that the production cost is very high and in that the production yield is also low even though mesoporous silica is produced under harsh conditions.

In order to overcome and solve these problems, it is needed to develop improved mesoporous silica which has sufficient specific surface area, pore size, volume, etc. so as to be capable of exhibiting excellent effect when applied to the fields of application of mesoporous silica, and is produced under economic conditions by an environmentally friendly and energy-saving production process.

### PRIOR ART DOCUMENTS

### Patent Documents

(Patent Document 1) KR 10-0806915 B1

### DISCLOSURE

### Technical Problem

An object of the present invention is to provide spherical mesoporous silica and a production method therefor.

Another object of the present invention is to provide spherical mesoporous silica with a large specific surface area and pore volume and a production method therefor.

Still another object of the present invention is to provide spherical mesoporous silica having improved economic efficiency and improved production yield as a result of performing a production process under mild conditions, and a production method therefor.

Yet another object of the present invention is to provide spherical mesoporous silica which exhibits excellent adsorption/desorption performance for large molecular components such as drugs and physiochemical substances due to a large specific surface area, large funnel-shaped pores caused by a dual-mesoporous structure, and a large pore volume, is capable of exhibiting an effect of sustainedly releasing an adsorbed component for a long time after adsorption, and thus may be used as a delivery carrier, and a production method therefor.

### Technical Solution

To achieve the above objects, spherical mesoporous silica according to an embodiment of the present invention is spherical porous silica including: multiple mesopores of irregular three-dimensional shape extending from a surface to an inside; and a groove shape formed on the particle surface and derived from the mesopores, wherein large mesopores starting from the surface of the groove shape are connected to the inside in a shape that gradually become smaller.

The average diameter of the porous silica particles is 50 to 900 nm.

The porous silica has a specific surface area of 500 to 1,500 m²/g.

The multiple mesopores have an average diameter of 3 to 4 nm in the inside and an average diameter of 20 to 25 nm on the surface. The mesopores have a funnel structure in which the average diameter increases from the inside to the surface of the silica, and the mesopores have a pore volume of 0.8 nm to 2.6 cm³/g.

A method for producing spherical mesoporous silica according to an embodiment of the present invention includes steps of: 1) adding alkylamine to a solvent, followed by stirring; 2) preparing a metal ion solution by dissolving a metal compound in the solution containing the alkylamine uniformly dispersed therein; 3) preparing a silica-coated complex micelle solution by adding a silica precursor to the metal ion solution, followed by stirring; 4) producing mesoporous silica by subjecting the silica-coated complex micelle solution to reduction with a reducing agent; 5) calcining the mesoporous silica at 400 to 700° C.; and 6) adding the calcined mesoporous silica to an aqueous acid solution, followed by stirring.

In the above, the silica precursor is selected from the group consisting of tetraethoxyorthosilicate (TEOS), tetramethoxyorthosilicate (TMOS), tetra(methylethylketoxime)silane, vinyl oxime silane (VOS), phenyl tris(butanone oxime)silane (POS), methyltriethoxysilane (MTES), methyltrimethoxysilane (MTMS), and mixtures thereof.

The reducing agent is selected from the group consisting of hydrogen (H₂), trisodium citrate, NaBH₄, phenylhydrazine·HCl, ascorbic acid, phenylhydrazine, LiAlH₄, N₂H₄, and hydrazine.

Hereinafter, the present invention will be described in more detail.

The spherical mesoporous silica of the present invention is spherical porous silica including: irregularly shaped mesopores extending from the surface to the inside; and grooves derived from the mesopores, wherein the grooves are connected to the internal mesopores in a shape in which the diameter thereof gradually decreases compared to the diameter at the surface.

The spherical mesoporous silica of the present invention refers to silica with a perfectly spherical shape, and refers to silica particles with a perfectly spherical shape, not unspecified, non-uniform, popcorn-shaped mesoporous silica formed by molecular assembly of a silica precursor.

The spherical silica is characterized in that multiple pores are formed inside, and the pores have a mesopore size. In general, porous silica is classified according to the size of the pores, and mesoporous silica refers to one having a pore diameter of 2 to 50 nm. The porous silica of the present invention is mesoporous silica in which pores with a mesopore size are formed.

As explained above, most conventional mesoporous silicas are not silicas with a perfectly spherical shape, but are those with a popcorn shape, which are made up of aggregates of silica precursors. As shown in FIG. 2, they are formed to have a significantly smaller specific surface area and pore volume than the spherical mesoporous silica particles of the present invention. Silica exhibits adsorption characteristics by its specific surface area and pores. Conventional mesoporous silica is in the form of popcorn in which silica precursors are aggregated, and has a smaller specific surface area and smaller total pore volume than the mesoporous silica of the present invention. Thus, when the conventional mesoporous silica is used, there is a problem in that the adsorption effect thereof is relatively low.

On the other hand, the mesoporous silica of the present invention has a perfectly spherical shape, includes mesopores formed inside, and has a larger specific surface area and pore volume than conventional mesoporous silica, as will be described later. Due to these characteristics, the mesoporous silica of the present invention has excellent adsorption effect by virtue of the mesopores formed inside, and is highly useful in various fields.

FIG. 1 is a transmission electron microscope photograph of the mesoporous silica of the present invention, and it can be seen that the mesoporous silica exists in a perfectly spherical shape. As such, the mesoporous silica of the present invention has a perfectly spherical shape and includes relatively small mesopores formed inside. The small mesopores inside are connected to the surface, and the average diameter of the mesopores formed increases nearly 10 times at the surface. Due to the above characteristics, the surface of the spherical mesoporous silica of the present invention is formed in a shape like a volcano crater. Due to the above-described characteristics of the silica including multiple mesopores, the spherical mesoporous silica of the present invention can exhibit large specific surface area and pore volume values.

Due to the above characteristics, the mesoporous silica of the present invention may be widely used in the following applications and may contribute to improving performance: a catalyst support; an anode material for secondary batteries; a coating material for super water repellency or to improve adhesive effect, etc.; a composite additive for membranes; a composite additive for noise and heat insulation; an additive for removal of contaminants; an additive for increasing thermal stability; a light-emitting polymer material; an antibacterial material; a drug delivery carrier; a dental composite material; a skin therapeutic agent; a pesticide delivery system; a fertilizer delivery system; a functional cosmetic composition material, etc.

Due to its characteristics in the above application fields, the mesoporous silica of the present invention may be used as silica with better heat resistance, noise prevention, and adsorption effects. In particular, the mesoporous silica of the present invention has better heat resistance, noise prevention, and adsorption effects due to its larger specific surface area and pore volume than general porous silica.

In addition, the mesoporous silica of the present invention may be effective as a drug delivery carrier as it can adsorb and desorb large-molecular pharmacologically active substances using the adsorption effect of the pores. In other words, the mesoporous silica can adsorb components such as drugs in the pores, and the mesoporous silica with the drug adsorbed may be injected in vivo using a method such as injection. The mesoporous silica injected in vivo slowly releases the adsorbed drug due to changes in the environment before and after injection in vivo. These characteristics make it possible to use the mesoporous silica as a drug delivery system (DDS) formulation.

Based on the above characteristics, the mesoporous silica may also be used in agriculture by adsorbing ingredients such as pesticides and fertilizers in addition to drugs.

The mesoporous silica exhibits an improved effect, when used as a functional cosmetic composition, due to the effect of the silica component itself. Silica is generally used as an extender pigment in cosmetic compositions. It is important for makeup products to be able to last for a long time without causing the makeup to become shiny or erased by sweat or sebum, especially secreted sebum. Ingredients that are mainly used in cosmetic powders determine the feel of use through complex effects such as applicability, spreadability and hygroscopicity of cosmetics depending on the size and shape of the particles.

This characteristic is an effect that appears due to the mixing of pigments and their interaction, and when the mesoporous silica of the present invention is used, it can improve the feel of use, such as skin applicability, spreadability, and hygroscopicity.

In addition, mesoporous silica is able to block ultraviolet rays, and thus may be used as a sunscreen.

Regarding the fields of application of the mesoporous silica of the present invention as described above, it will be said that the specific surface area and pore volume act as important factors in order for general mesoporous silica to exhibit better effects.

The specific surface area is the value obtained by dividing the surface area of the material by the weight, and corresponds to a very important value in interfacial phenomena. A larger specific surface area value indicates a larger surface area per weight.

The larger the surface area, the greater the area and probability of contact with the component to be adsorbed by the mesoporous silica.

In addition, the pore volume refers to the volume of the entire pores inside the mesoporous silica, and the larger the pore volume, the greater the amount of the component adsorbed in the mesopores.

The larger the specific surface area and pore volume value, the greater the amount of the component adsorbed in the mesoporous silica when using the same mesoporous silica, indicating that even when the mesoporous silica is used in a smaller amount, it may exhibit a better effect.

As an example, when the mesoporous silica of the present invention and conventional popcorn-shaped mesoporous silica are used in equal amounts as DDS carriers for drug delivery, they show a large difference in the amount of drug adsorbed, and when these mesoporous silicas are injected in equal amounts, they show a large difference in the drug release period. Additionally, when the same dose of drug is to be injected, the amount of mesoporous silica used may be reduced.

The spherical mesoporous silica particles of the present invention are nanoparticles with an average diameter of 50 to 900 nm, mainly 100 to 300 nm, but the average particle is not limited to the above example and may be adjusted depending on the type of use.

The spherical mesoporous silica of the present invention may be used for targeted delivery of suitable active pharmaceutical ingredients in cancer treatment and other applications due to its high surface area, easy surface modification, and biocompatibility. The spherical mesoporous silica may exhibit not only excellent drug component adsorption performance but also an improved drug release effect, because the mesopores are not only formed inside, but also complexly intertwined with the surface, and are formed in an open form.

The mesoporous silica of the present invention according to FIG. 1 has a specific surface area of 500 to 1,500 m²/g, mainly 800 to 1,250 m²/g, but the specific surface area is not limited to the above example and may be adjusted depending on the type of use.

Conventional mesoporous silica has a specific surface area of 600 to 700 m²/g or less, mainly 300 to 400 m²/g, and the actual measured value is 395 m²/g. It can be seen that the specific surface area differs by at least three times from that of the mesoporous silica of the present invention, although some differences may occur depending on the actual measurement conditions.

As explained previously, the difference in specific surface area means that the area of contact with the material to be adsorbed is large, and the mesoporous silica of the present invention is able to adsorb a larger amount of a component within a shorter time than conventional mesoporous silica.

In addition, the average diameter of the internal pores of the mesoporous silica of the present invention according to FIG. 1 is 2 to 10 nm, or 3 to 5 nm, but may be adjusted depending on the type of use.

It can be seen that the average diameter of the external pores of the mesoporous silica according to FIG. 2 is 20 to 25 nm, indicating a larger pore size.

On the other hand, in terms of the total volume of pores, the spherical mesoporous silica of the present invention has a pore volume of 0.8 to 2.6 cm³/g, or 0.8 to 1.5 cm³/g, or 0.90 to 0.97 cm³/g, but the pore volume is not limited to the above example and may be adjusted depending on the intended use, etc. during production.

Accordingly, the mesoporous silica of the present invention is characterized in that a large number of mesopores with a large volume and a small average diameter are formed. In addition, as described above, the mesopores are formed to be connected not only to the inside but also to the surface. Due to the above characteristics, on the surface of the mesoporous silica of the present invention, fine grooves induced by mesopores are formed. Due to the above characteristics, the mesoporous silica of the present invention has a large specific surface area, can exhibit rapid adsorption characteristics due to its large specific surface area, can adsorb a relatively large amount of a component, and has the effect of trapping in the small internal mesopores, which exhibits a great ability for sustained-release desorption.

Specifically, the fine grooves on the surface are connected to the internal mesopores in a shape whose diameter gradually decreases starting from the surface. That is, the mesoporous silica is characterized in that the diameter of the groove formed on the surface is formed to be larger than that of the mesopore connected to the inside. The shape of the mesopore connected to the groove is similar to a funnel shape as shown in FIG. 7, and the entrance diameter of the large mesopore formed on the surface greatly differs from the diameter of the internal mesopore connected.

As described later, when producing the porous mesoporous silica, a reduction process is performed. Hydrogen gas generated in the reduction process is formed inside the silica particles, and connects mesopores to the surface while it flows out. As the hydrogen gas is ejected to the outside, grooves with a larger diameter are formed on the surface, like craters that occur during a volcanic eruption.

More specifically, the diameter of the groove is characterized by having a size of about 5 to 10 times the diameter of the internal mesopore connected thereto. That is, the diameter ratio of the groove formed on the surface to the internal mesopore connected thereto is 5:1 to 10:1, mainly 7:1 to 8:1, but is not limited to the above ratio. When the diameter ratio is within the above range, it is possible to produce mesoporous silica with a larger specific surface area than conventional mesoporous silica.

A method for producing spherical mesoporous silica according to another embodiment of the present invention may include steps of: 1) adding alkylamine to a solvent, followed by stirring; 2) preparing a metal ion solution by dissolving a metal compound in the solution containing the alkylamine uniformly dispersed therein; 3) preparing a silica-coated complex micelle solution by adding a silica precursor to the metal ion solution, followed by stirring; 4) producing mesoporous silica by subjecting the silica-coated complex micelle solution to reduction with a reducing agent; 5) calcining the mesoporous silica at 400 to 700° C.; and 6) adding the calcined mesoporous silica to an aqueous acid solution, followed by stirring.

More specifically, the alkylamine may be an amine-based template, specifically an alkylamine having an alkyl group having 5 to 18 carbon atoms. More specifically, the alkylamine is selected from the group consisting of dodecylamine, decylamine, tetradecylamine, and mixtures thereof, but is not limited to the above examples.

The solvent is more specifically an aqueous alcohol solution, wherein the alcohol is selected from the group consisting of methyl alcohol, ethyl alcohol, propyl alcohol, butanol, and pentanol, and is preferably ethyl alcohol, but is not limited to the above example and any alcohol may be used without limitation.

The aqueous alcohol solution is a mixture of 5 to 15 wt % of alcohol and 85 to 95 wt % of purified water. If the alcohol is contained in an amount of less than 5 wt %, a problem may arise in that the alkylamine is not sufficiently dissolved because the amount of alcohol used is insufficient, and if the alcohol is contained in an amount of more than 10 wt %, the alkylamine will be diluted with the alcohol, resulting in a decrease in the overall reaction rate.

In step 1), a solution is prepared by adding 15 to 25 ml of water and 1 to 5 ml of alcohol per mmol of alkylamine. If the amount of the aqueous alcohol solution added is smaller than the lower limit of the above range, a problem may arise in that the reaction does not occur because the alkylamine is not easily dissolved, and if the amount of the aqueous alcohol solution added is larger than the upper limit of the above range, it may affect the yield.

Step 2) is a step of preparing a metal ion solution by dissolving a metal compound in the solution containing the alkylamine uniformly dispersed therein.

More specifically, the metal compound is added to the solution and the mixture is stirred for 30 to 90 minutes so that the metal ions are uniformly dispersed in the solution containing the alkylamine dissolved therein. Preferably, stirring with a magnetic bar may be performed for 60 minutes, thereby preparing a solution containing metal ions uniformly dispersed therein.

More specifically, as the metal compound, any compound, which is selected from the group consisting of lithium (Li), magnesium (Mg), aluminum (Al), manganese (Mn), zinc (Zn), chromium (Cr), iron (Fe), cobalt (Co), nickel (Ni), tin (Sn) compounds, and mixtures thereof and may be dissolved in water to form metal ions, may be used without limitation. Preferably, the metal compound may be selected from the group consisting of Zn(NO₃)₂, ZnCl₂, ZnSO₄, Zn(OAc)₂, SnCl₂, and Sn(OAc)₂, but is not limited to the above examples.

A complex compound may be obtained by adding metal ions to the solution containing the alkylamine dissolved therein and stirring. Specifically, the complex compound is a form in which metal ions are contained in alkylamine micelles. The amount of the metal ions added is preferably 4 to 5 ml of a 0.1 M aqueous metal ion solution per 1 mmol of alkylamine, but it is not limited to the above example and may be any amount within the range in which the complex compound may be prepared.

A silica-coated complex micelle solution is prepared by adding a silica precursor to the metal ion solution and stirring.

The silica precursor may be selected from the group consisting of tetraethoxyorthosilicate (TEOS), tetramethoxyorthosilicate (TMOS), tetra(methylethylketoxime)silane, vinyl oxime silane (VOS), phenyl tris(butanone oxime)silane (POS), methyltriethoxysilane (MTES), methyltrimethoxysilane (MTMS), and mixtures thereof, and is preferably tetraethoxyorthosilicate (TEOS), but is not limited to the above examples and any silica precursor may be used without limitation.

When the silica precursor is added to the aqueous solution and stirred at room temperature of 15 to 25° C., the silica precursor is located inside the complex compound. That is, the complex compound is in the form of alkylamine micelles to which metal ions are bound. The interior of the complex compound is hydrophobic in nature, and the reaction proceeds in a state in which the hydrophobic silica precursor is trapped inside the micelles. Thereafter, the silica precursor undergoes a hydrolysis reaction through continuous stirring, and spherical mesoporous silica is synthesized through the hydrolysis. The spherical mesoporous silica is one in which metal ions are bound by reaction and zincosilicate is formed in the internal pores. The zincosilicate is a form in which metal ions are bound.

The silica precursor may be added in an amount ranging from 4 to 10 mmol per mmol of alkylamine, but is not limited to the above range and may be added in any amount as long as spherical mesoporous silica can be formed. If the amount of the silica precursor added is less than 4 mmol, a problem may arise in that the silica layer thickness becomes excessively thin, thus impairing the stability of the structure, and if the amount of the silica precursor added is more than 10 mmol, the silica outer wall thickness becomes excessively thick and other structures may be formed.

Afterwards, a process of reducing the metal ions by adding a reducing agent is performed.

The reducing agent is selected from the group consisting of hydrogen (H₂), trisodium citrate, NaBH₄, phenylhydrazine·HCl, ascorbic acid, phenylhydrazine, LiAlH₄, N₂H₄, and hydrazine, and is preferably NaBH₄, but is not limited to the above examples and any reducing agent may be used without limitation.

The reducing agent may be added in an amount of 0.5 to 2 N per 1.0 N concentration of metal ions, but is not limited to the above range and any amount may be used without limitation. If the amount of the reducing agent added is less than 0.5 N, a problem may arise in that the conversion rate to metal particles decreases, and if the amount of the reducing agent added is more than 2 N, the conversion rate to metal particles does not increase significantly and an excessive amount of the reducing agent may remain.

Metal ions present inside the spherical mesoporous silica are reduced to metal by the reducing agent. When reduction of the metal ions progresses, hydrogen gas (H₂) is formed, and the hydrogen gas is discharged to the outside of the mesoporous silica. As the hydrogen gas is discharged to the outside as described above, expanded mesopores are formed in the mesoporous silica, and further expanded pores on the surface are formed by the mesopores to form fine grooves on the surface.

Thereafter, washing and drying processes are performed, thereby producing spherical mesoporous silica in which the metal is bound to the inside of the mesopores.

More specifically, spherical mesoporous silica having the metal bound thereto is produced by the reduction reaction, vacuum-filtered at a pressure of 20 to 40 mmHg, washed 2 to 4 times with distilled water, and washed 2 to 4 times with ethyl alcohol at 50 to 70° C.

After the washing process, drying is performed at 60 to 80° C. for 1 to 3 hours, thereby producing spherical mesoporous silica.

The spherical mesoporous silica has the metal bound to the inside thereof. To remove the bound metal, the spherical mesoporous silica is added to an aqueous acid solution and stirred.

The aqueous acid solution may be selected from the group consisting of aqueous hydrochloric acid solution, aqueous sulfuric acid solution, aqueous nitric acid solution, aqueous acetic acid solution, and mixtures thereof. Preferably, an aqueous hydrochloric acid solution, which is a dilute hydrochloric acid obtained by diluting hydrochloric acid, a strong acid, with water, may be used. However, the aqueous acid solution is not limited to the above examples, and any aqueous acid solution that can remove the metal bound to the inside of the mesopore may be used.

In the production of mesoporous silica according to a conventional art, there is a problem in that the production environment is very harsh due to the use of strong acid.

On the other hand, in the case of the present invention, rather than using strong acid as is, an aqueous acid solution is used, which may not only improve the production environment compared to the use of strong acid, but also prevent environmental pollution problems through the use of the aqueous acid solution.

In addition, the aqueous acid solution is used only in the step of removing the metal bound to the inside of the produced mesoporous silica, and is not used during the production of mesoporous silica. This suggests that the aqueous acid solution is used only for a relatively short period of time, and thus the production environment is improved.

More specifically, mesoporous silica with the metal bound to the inside of the mesopores is produced through washing and drying processes, and then placed in an aqueous hydrochloric acid solution and stirred for 1 to 3 hours. Thereafter, only mesoporous silica is collected by filtration, washed 2 to 4 times with distilled water, and then dried at 60 to 80° C. for 4 to 6 hours.

### Advantageous Effects

According to the spherical mesoporous silica and method for producing the same according to the present invention, it is possible to provide spherical mesoporous silica, which has a large specific surface area and pore volume and has improved economic efficiency and production yield as a result of simplifying the production process, and a method for producing the same.

In addition, the spherical mesoporous silica of the present invention has excellent adsorption performance due to expanded pores with a funnel shape, and may exhibit a maximum effect of releasing the active ingredient after adsorption.

### BRIEF DESCRIPTION OF DRAWINGS

FIG. 1 is a TEM photograph of spherical mesoporous silica according to an embodiment of the present invention.

FIG. 2 is a SEM photograph of spherical mesoporous silica according to an example of the present invention.

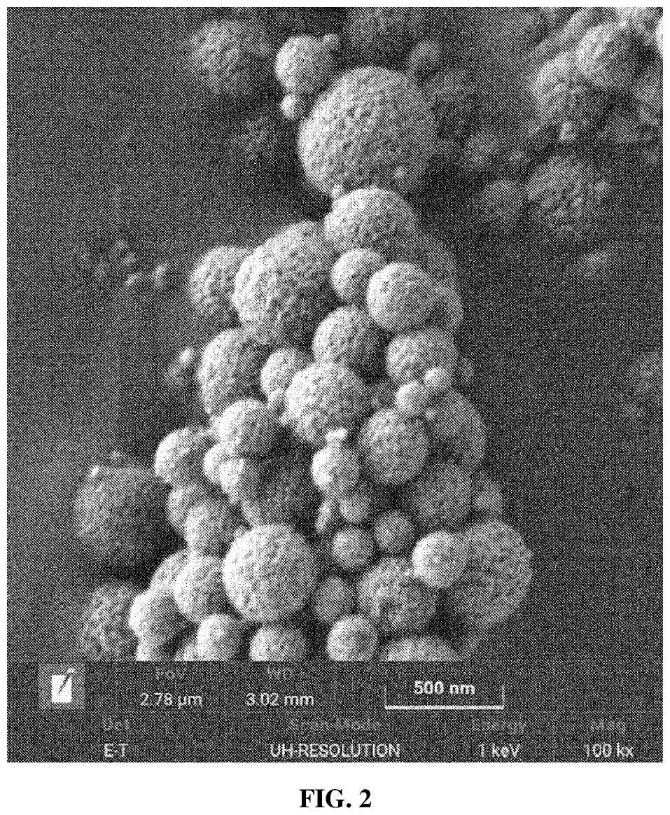

FIG. 3 shows the results of component analysis of spherical mesoporous silica according to an embodiment of the present invention.

FIG. 4 shows the results of nitrogen gas adsorption and desorption isotherms of spherical mesoporous silica according to an embodiment of the present invention.

FIG. 5 shows the results of measuring the total pore volume depending on the pore diameter of spherical mesoporous silica according to an embodiment of the present invention.

FIG. 6 shows the results of measuring and analyzing the particle size distribution of spherical mesoporous silica according to an embodiment of the present invention.

FIG. 7 is a TEM measurement photograph of silica in which mesopores are formed in a 2D hexagonal shape, according to an embodiment of the present invention.

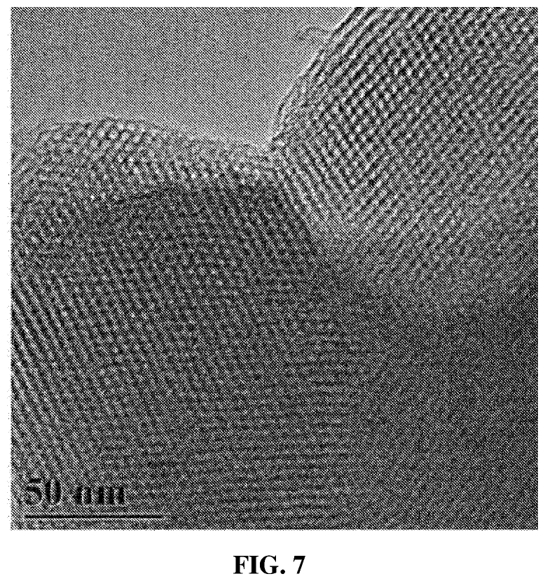

FIG. 8 is a conceptual diagram showing the shape of a surface groove and a mesopore connected thereto, according to an embodiment of the present invention.

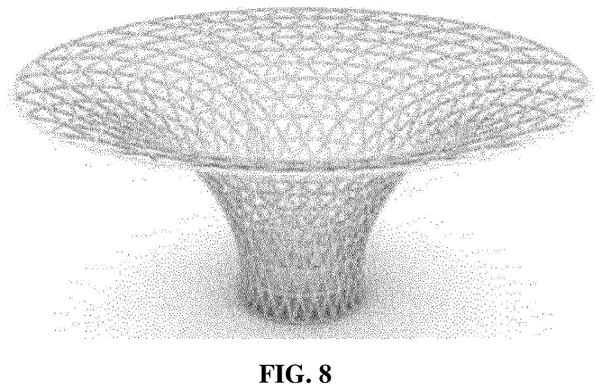

FIG. 9 shows the results of analyzing the specific surface area, pore volume, and pore diameter of spherical mesoporous silica according to an embodiment of the present invention.

### BEST MODE

The present invention is directed to spherical mesoporous silica including: multiple mesopores of irregular three-dimensional shape extending from the surface to the inside; and grooves formed on the surface, wherein the grooves are derived from the multiple mesopores, and the grooves formed on the surface and the mesopores connected to the grooves have a funnel shape in which the average diameter of the mesopores connected to the surface gradually decreases.

### MODE FOR INVENTION

Hereinafter, examples of the present invention will be described in detail so that the present invention can be easily carried out by those skilled in the art. However, the present invention may be embodied in many different forms and is not limited to the examples described herein.

### Production Examples

### Production of Spherical Mesoporous Silica

1 mmol of dodecylamine (DDA) was added to 20 mL of a 10% aqueous solution of ethyl alcohol, and then stirred for 1 hour at 60±1° C. until the aqueous ethyl alcohol solution became transparent. Next, the solution was kept with stirring at room temperature for about 1 hour.

Thereafter, 5 ml of an aqueous solution containing metal ions as shown in Table 1 below was added thereto and then stirred with a magnetic bar for about 1 hour. 4 mmol of tetraethoxyorthosilicate (TEOS), a silica precursor, was added to the solution to which the metal ions have been additionally added, followed by vigorous stirring at room temperature (20 to 25° C.) for 1 hour.

Thereafter, 0.2 mmol of NaBH₄, a reducing agent, was added to the stirred solution to obtain spherical mesoporous silica, which was then vacuum-filtered at a pressure of 30 mmHg. Next, the filtered spherical mesoporous silica was washed three times with 200 ml of distilled water and three times with 100 ml of ethyl alcohol at 60° C.

After completion of the washing process, the mesoporous silica was dried at a temperature of 70° C. for 2 hours and calcined at 550° C. for 6 hours. Next, the calcined mesoporous silica was added to a 1 N hydrochloric acid aqueous solution, stirred for 2 hours, filtered, washed three times with 200 ml of distilled water, and then dried at 70° C. for 5 hours.

TABLE 1

| | | Content (molar concentration) in |
|---|---|---|
| | Metal compound | aqueous solution |
| Example 1 | Zn(NO₃)₂ | 0.1 |
| Example 2 | ZnCl₂ | 0.1 |
| Example 3 | ZnSO₄ | 0.1 |
| Example 4 | Zn(OAc)₂ | 0.1 |
| Example 5 | SnCl₂ | 0.1 |
| Example 6 | Sn(OAc)₂ | 0.1 |

### Experimental Example 1

### Checking of Formation of Spherical Mesoporous Silica Particles

Whether spherical mesoporous silica was formed was checked depending on the type of metal compound in Examples 1 to 6.

Whether spherical mesoporous silica was produced in a perfectly spherical shape was examined by SEM imaging. The results are shown in Table 2 below.

TABLE 2

| | Particle formation |
|---|---|
| Example 1 | ∘ |
| Example 2 | ∘ |
| Example 3 | ∘ |
| Example 4 | ∘ |
| Example 5 | ∘ |
| Example 6 | ∘ |

As shown in Table 2 above, it was confirmed that uniform spherical mesoporous silica was produced regardless of the type of metal compound.

### Experimental Example 2

### Component Analysis of Spherical Mesoporous Silica

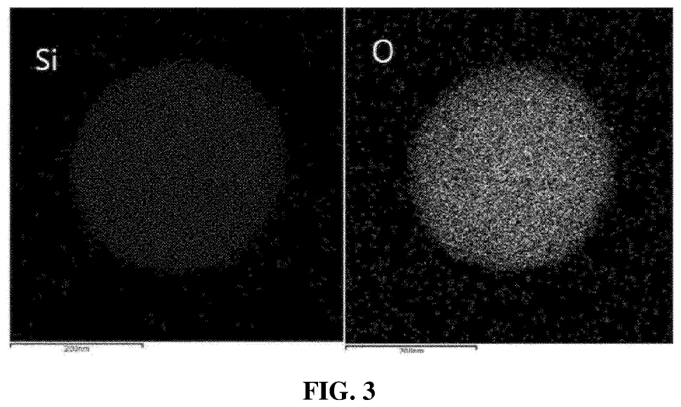

The component analysis results for the spherical mesoporous silica produced using the metal compounds in Examples 1 to 6 are shown in FIG. 3 and Table 3 below.

TABLE 3

| Element | Weight % | Atomic % |
|---|---|---|
| O | 52.13 | 65.66 |
| Si | 47.87 | 34.34 |

| | |
|---|---|
| Total | 100.00 |

Referring to FIG. 3 and Table 3, it can be found that the spherical mesoporous silica of the present invention is composed only of Si and O.

In other words, when mesoporous silica including a metal in mesopores is produced and treated with an acidic solution in order to produce the spherical mesoporous silica of the present invention, the metal included in the mesopores may be completely removed, thereby producing silica in which no metal exists in the mesopores.

### Experimental Example 3

### Evaluation of Physical Properties of Spherical Mesoporous Silica

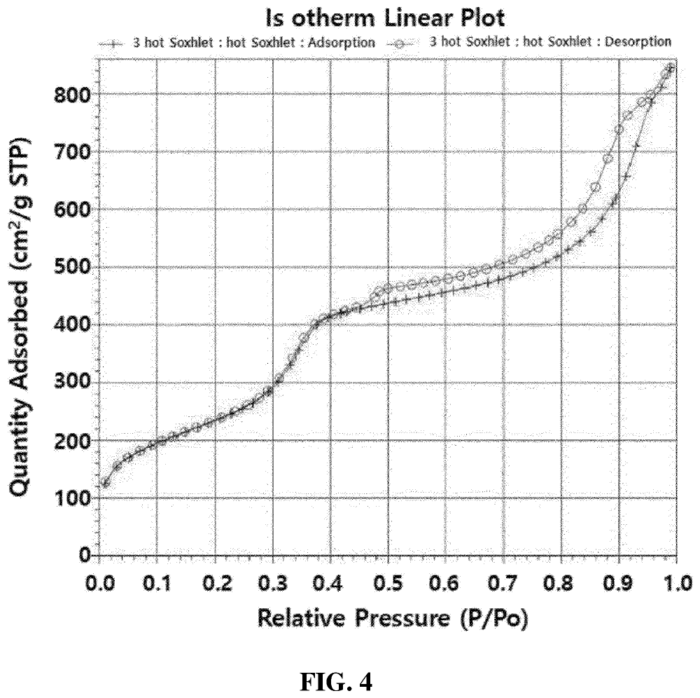

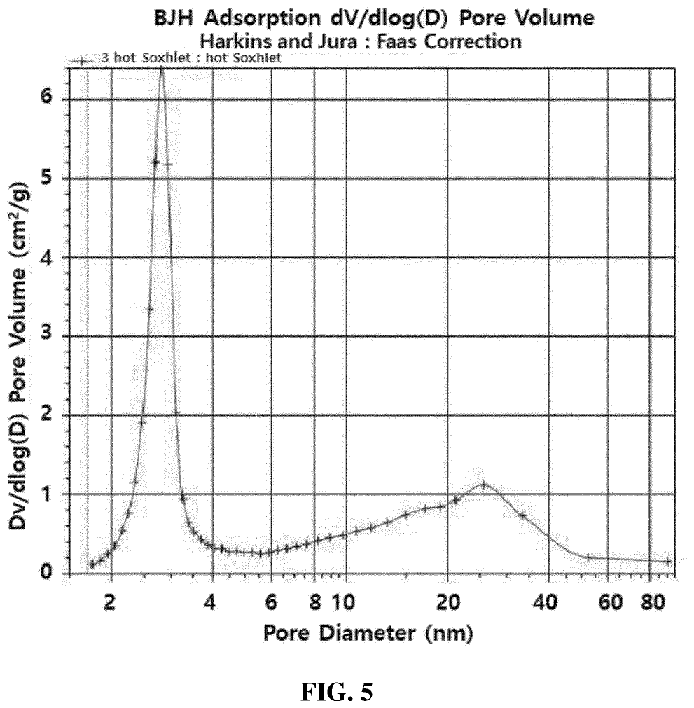

The measurement results for the specific surface area, average pore diameter, and total pore volume of the spherical mesoporous silica produced using the metal compound in Example 1 are shown in FIGS. 4 and 5 and Table 4 below.

The measurements were performed using a particle size analyzer (Mastersizer 3000). As comparative examples, the results of analysis of commercially available mesoporous silica products, including MCM-41 NP, Aldrich, MCM-41 (purchased from Aldrich), and ACS's product, were used for comparison.

TABLE 4

| | | MCM-41 | | MCM-41 | |
|---|---|---|---|---|---|
| | Example 1 | NP | Aldrich | (Aldrich) | ACS |
| Particle size | 100 to 500 | 600 to 700 | 400 to 600 | — | 100 to 1,000 |
| distribution (nm) | | | | | |
| BJH adsorption | 5.03 | 2.7 | 4 | 2.1 to 2.7 | 3.4 |
| average pore size | | | | | |
| (nm) | | | | | |
| BET specific | 886 | 585 | 300 to 400 | About 1,000 | About 850 |
| surface area | | | | | |
| (m²/g) | | | | | |
| Pore volume | 1.36 | 0.49 | 0.2~0.4 | 0.34 | 0.75 |
| (cm³/g) | | | | | |
| Pore structure | 3D | 2D | — | 2D | 2D |
| | wormhole | hexagonal | | hexagonal | hexagonal |

Referring to Table 4 above, it was found that the average particle size of the mesoporous silica of the present invention was smaller than that of the conventional commercially available mesoporous silica, but showed large differences in the pore size, specific surface area, and pore volume.

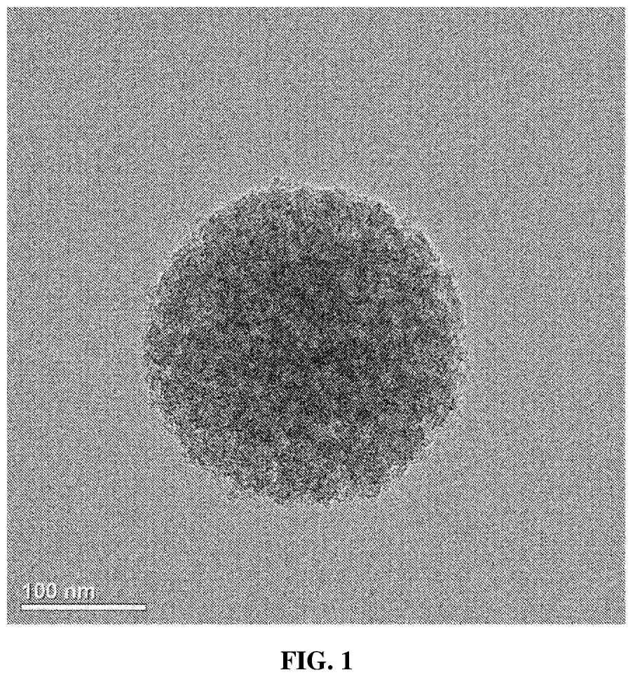

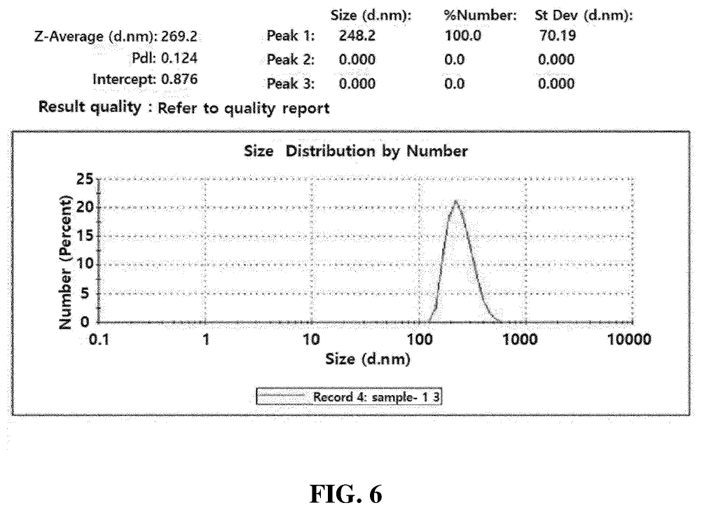

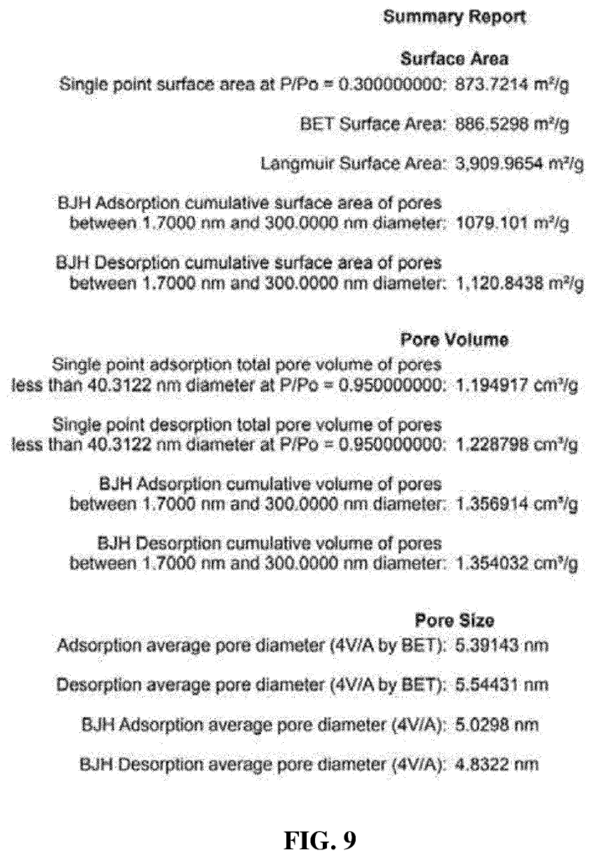

These differences are due to the difference in the pore structure. As shown in FIGS. 1 and 3, the mesoporous silica of the present invention has a 3D wormhole (3D irregular pores) in which mesopores are formed in an irregular shape extending from the surface to the inside of the mesoporous silica. This can be confirmed more clearly through the analysis results for silica shown in FIG. 9. On the other hand, it can be seen that the ACS's product shown in FIG. 6 has a 2D hexagonal structure, which is different from the 3D wormhole structure of the present invention.

According to the particle size analysis results, the mesoporous silica of the present invention has a small average particle size, but can exhibit excellent specific surface area and pore volume values as a large number of irregular mesopores extending from the surface to the inside are formed therein.

In addition, referring to FIG. 5, it can be seen that the results of measurement of the mesopore diameter for the mesoporous silica of the present invention show peaks around 3.4 nm and 25 nm. The peak at 3.4 nm indicates the diameter of the internal pore, and the peak at 25 nm indicates the diameter of the groove formed on the surface.

This means that the mesoporous silica of the present invention has a funnel shape in which the groove formed on the surface has a larger diameter than the internal pore. According to the experimental results, it can be confirmed that the diameter of the groove formed on the surface is 7 to 8 times larger than the diameter of the internal mesopore.

### Experimental Example 4

### Experiment on Drug Adsorption and Release Effects of Spherical Mesoporous Silica

In order to evaluate the drug adsorption and release effects of the spherical mesoporous silica, the effects of adsorbing and releasing vitamin C were evaluated.

As a comparative example, MCM-41 NP, which is mesoporous silica currently available on the market, was used.

Each mesoporous silica was dispersed in distilled water containing vitamin C completely dissolved therein, and the dispersion was stirred at room temperature for 24 hours. The mesoporous silica having vitamin C adsorbed thereon was washed carefully with distilled water to remove the adsorbed vitamin C from the external surface and dried at 60° C.

The weight reduction of each sample was measured through a weight loss experiment using TGA.

TABLE 5

| | Example 1 | MCM-41 NP |
|---|---|---|
| Weight reduction rate | 14.9% | 5.5% |

According to the above experimental results, it was confirmed that the weight reduction rate was larger in the Example. In light of the results of measurement of the weight reduction rate, it was confirmed that the mesoporous silica of the present invention exhibited better drug adsorption and release effects than the commercially available mesoporous silica.

Although the preferred embodiments of the present invention have been described in detail above, the scope of the present invention is not limited thereto, and various modifications and improvements can be made by those skilled in the art without departing from the basic concept of the present invention as defined in the following claims, and also fall within the scope of the present invention.

### INDUSTRIAL APPLICABILITY

The present invention relates to spherical mesoporous silica and a production method therefor, and specifically, to spherical (ball type) porous silica having a groove-shaped surface derived from mesopores and a preparation method therefor.

1. Spherical mesoporous silica comprising:
multiple mesopores of irregular three-dimensional shape extending from a surface to an inside; and
grooves formed on the surface,
wherein the grooves are derived from the multiple mesopores, and the grooves formed on the surface and the mesopores connected to the grooves have a funnel shape in which an average diameter of the mesopores connected to the surface gradually decreases.

2. The spherical mesoporous silica according to claim 1, wherein the mesoporous silica has an average diameter of 50 to 900 nm.

3. The spherical mesoporous silica according to claim 1, wherein the mesoporous silica has a specific surface area of 500 to 1,500 m²/g.

4. The spherical mesoporous silica according to claim 1, wherein the mesopores have an average diameter of 2 to 10 nm and a pore volume of 0.8 to 2.6 cm³/g.

5. A method for producing spherical mesoporous silica comprising steps of:
1) adding alkylamine to a solvent, followed by stirring;
2) preparing a metal ion solution by dissolving a metal compound in the solution containing the alkylamine uniformly dispersed therein;
3) preparing a silica-coated complex micelle solution by adding a silica precursor to the metal ion solution, followed by stirring;
4) producing mesoporous silica by subjecting the silica-coated complex micelle solution to reduction with a reducing agent;
5) calcining the mesoporous silica at 400 to 700° C.; and
6) adding the calcined mesoporous silica to an aqueous acid solution, followed by stirring.

6. The method according to claim 5, wherein the silica precursor is selected from the group consisting of tetraethoxyorthosilicate (TEOS), tetramethoxyorthosilicate (TMOS), tetra(methylethylketoxime)silane, vinyl oxime silane (VOS), phenyl tris(butanone oxime)silane (POS), methyltriethoxysilane (MTES), methyltrimethoxysilane (MTMS), and mixtures thereof.

7. The method according to claim 5, wherein the reducing agent is selected from the group consisting of hydrogen (H₂), trisodium citrate, NaBH₄, phenylhydrazine·HCl, ascorbic acid, phenylhydrazine, LiAlH₄, N₂H₄, and hydrazine.
